(19) United States
(12) Patent Application Publication
(10) Pub. No.: US 2009/0322562 A1
(43) Pub. Date: Dec. 31, 2009

(54) TRAFFIC DEVICE FOR DISPLAYING A TRAFFIC SIGN

(76) Inventor: Thomas Sachse, Bruckmuhl (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/492,441

(22) Filed: Jun. 26, 2009

(30) Foreign Application Priority Data
Jun. 30, 2008 (DE) 10 2008 030 335.6

(51) Int. Cl. G08G 1/095

(52) U.S. Cl. 340/907

(57) ABSTRACT

A traffic device is provided for showing a traffic sign on a carriageway along which a vehicle is able to drive. The traffic device has a projection apparatus for creating an optical projection of the traffic sign on the carriageway which is such that the projected traffic sign is perceivable by a driver.

### CROSS REFERENCE TO RELATED APPLICATIONS

This application claims priority of German application No. 10 2008 030 335.6 DE filed Jun. 30, 2008, which is incorporated by reference herein in its entirety.

### FIELD OF INVENTION

The invention relates to a traffic device for displaying a traffic sign on a carriageway along which a vehicle is able to drive.

### BACKGROUND OF INVENTION

Traffic signs here should be understood as all traffic information able to be represented by images and/or by text characters. Among other things this includes the prohibitive signs and danger signs in accordance with the road traffic act as well as carriageway markings and also information texts about distances to destinations, signposts as well as further information for directing traffic. These traffic signs are shown by boards arranged alongside or over the carriageway or also by traffic devices attached to the surface of the carriageway or let into the latter, such as marker coatings or raised light markers.

An information or traffic sign able to be fitted to the carriageway is known from utility model publication DE 200 03 601 U1, such as a traffic direction arrow which features a series of prisms arranged alongside one another on a sublayer. This causes the traffic direction arrow from one direction of view to show a different colored design from that shown from another direction of view, with the colored design differing from the color of the carriageway coating. The sublayer with the prisms is embodied raised above the carriageway surface.

### SUMMARY OF INVENTION

These types of traffic sign applied to the carriageway or also let into the carriageway for displaying a traffic sign are subjected by heavy goods traffic in particular to a significant level of wear and therefore demand a high maintenance outlay. On the other hand these types of traffic device suffer from the disadvantage that with a snow-covered carriageway they are not easily visible or cannot be seen at all by road users.

The object of the invention is thus to provide a traffic device of the type stated at the start which requires a low level of maintenance outlay and can display the traffic sign visibly even on a snow-covered carriageway.

The object is achieved by a generic traffic device which features a projection apparatus for generating an optical projection of the traffic sign on the carriageway, with the traffic device being arranged on the side of the carriageway such that the projected traffic sign is able to be perceived by a driver of the vehicle. A traffic sign projected onto the carriageway is not able to be covered by snow or dirt and is thus easily visible to the vehicle driver even under these conditions. Nor are such signs subject to any wear caused by traffic rolling over them which leads to considerable maintenance savings. In addition it is possible without any great effort to switch on or switch off a traffic sign projected onto the carriageway or to replace it by another sign. Finally traffic signs created inventively by being projected onto the carriageway demand less space than previously known boards or panels set up next to the carriageway or hanging over the carriageway, which also involve covering extensive surfaces; this enables inventive traffic devices to be employed to advantage in situations where little space is available—such as in road tunnels.

In an advantageous embodiment of the inventive traffic device the projection device comprises a light source for transmitting a beam of light and a redirection device for influencing a direction of the beam of light emitted. The beam of light can be embodied as a laser or example which sends out a focused monochromatic light beam. This light beam passes through a redirection device which features a system of adjustable mirrors, so that the light beam can be directed precisely to a specific position of the carriageway in order to project the traffic sign to be displayed onto said position.

In a preferred embodiment of the inventive traffic device the projection apparatus comprises a control device for co-ordinated control of the light source and/or the redirection device. This enables the beam duration of the light source to be matched to the directional influence by the redirection device in order to create parts of characters of the traffic sign to be projected limited in their surface area.

In a preferred embodiment of the inventive traffic device the control device features a memory unit for storing a plurality of projection patterns assigned to projectable traffic signs as well as a processing unit for executing a projection pattern. The inventive traffic device can thus be supplied even before installation with projection patterns for the traffic signs to be displayed which are realized in stored and executable software programs. The position and alignment in which the projection apparatus involved is arranged relative to the carriageway onto which the traffic sign is to be projected can be taken into account in such cases as parameters.

In a preferred embodiment of the inventive traffic device the light source is embodied for emitting an invisible light beam, with the carriageway surface having a coating which is able to be excited into emitting visible light when irradiated by the invisible light beam. This avoids drivers of vehicles using the road being confused or distracted by the light emission of the projection apparatus. The guidance of the road users is improved and traffic safety is enhanced in this way.

In a further advantageous embodiment of the inventive traffic device the projection apparatus is embodied for projection of multicolored traffic signs. For this purpose a number of light sources with different colors or also corresponding color filter devices can be provided in the projection apparatus. On the one hand this enables traffic signs to be projected onto the carriageway in the colored design known from the conventional traffic signs, which allows carriageway users to recognize them again quickly. On the other hand it is possible on snow-covered carriageways for example to produce higher-contrast carriageway markings.

In another advantageous embodiment of the inventive traffic device the projection apparatus is arranged above the carriageway and is essentially aligned perpendicular to the carriageway. This type of overhead arrangement on masts or on gantries does not have any adverse effect on road users. Aligned essentially perpendicular to the carriageway is to be understood as an angle between the light beam and the carriageway surface being in a range of between 90° and 45°.

In a further advantageous embodiment of the inventive traffic device a number of projection apparatuses are arranged in a distributed alignment so that each projects the same traffic sign onto the same point of the carriageway from different directions. This produces a redundant generation of a traffic sign projection which avoids the traffic sign not being visible if the projection is obscured by a vehicle.

In a further advantageous embodiment of the inventive traffic device the traffic sign is embodied as a static projection of a prohibitive sign, warning sign, danger sign, direction arrow, of a point or line carriageway marking or of an information text.

In an alternate embodiment of the inventive traffic device the traffic sign is embodied as a dynamic projection of a moving text or of a moving light. In this way, in addition to projections of traffic signs which do not change over time, dynamic projections are also possible for example of moving text building up letter by letter or moving lights at carriageway restrictions for road works.

### BRIEF DESCRIPTION OF THE DRAWINGS

Further advantages and features of the inventive traffic device are described below with reference to the drawings, in which

FIG. 1 shows an inventive traffic device for displaying a carriageway marking,

FIG. 2 shows a projection apparatus of an inventive traffic device, as schematic diagrams.

### DETAILED DESCRIPTION OF INVENTION

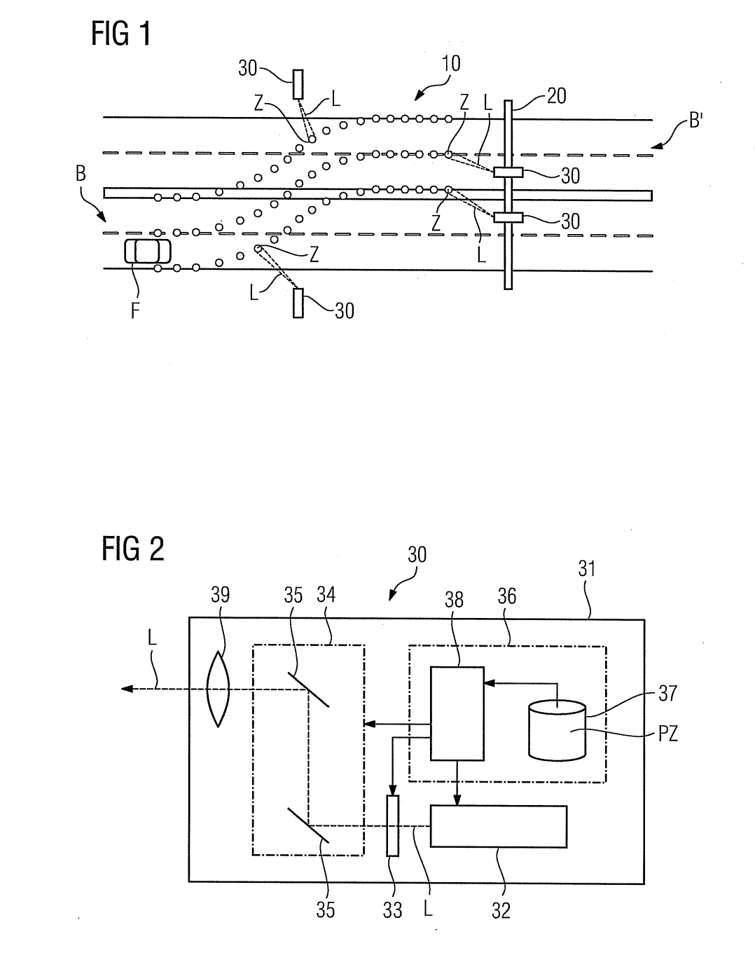

In accordance with the exemplary embodiment shown in FIG. 1 an inventive traffic device 10 features a plurality of projection apparatuses 30 which are partly arranged on a gantry 20 spanning the carriageways B or B′ of a freeway and are partly arranged on masts erected to the sides of the carriageways B or B′. The projection apparatuses 30 generate by means of a controlled light beam L a projection of the traffic sign Z onto the carriageway B or B′. In the exemplary embodiment shown the projected traffic sign Z consists of a plurality of raised markers which delimit lanes of a carriageway and B —depending for example on flow through road works—are transferred onto the corresponding lanes of the opposite carriageway B′. The driver of a vehicle traveling on carriageway B can clearly see the projected traffic sign Z and is safely routed from his carriageway B onto the opposite carriageway B′.

According to FIG. 2 a projection apparatus 30 has a housing 31, in which are arranged a light source 32 embodied as a laser for emitting a light beam L and also a redirection device 34 for influencing a beam direction of the emitted light beam L. The redirection device 34 comprises a system of mirrors 35 which are able to be moved or deflected to match the desired emission direction by adjustment means not shown in the figure. Also arranged in the housing 31 of the projection apparatus 30 is a control device 36 which features a memory unit 37 and a processing unit 38. Stored in the memory unit 37 is a plurality of projection patterns PZ, with each projection pattern being assigned to a traffic sign Z to be projected. The projection patterns PZ are stored as parameters and software code which, on desired projection of a specific traffic sign Z, is executed in the processing unit 38. In the execution of a projection pattern PZ the processing unit 38 controls the light source 32 and the redirection device 34 in a manner in which they are matched to each other. This provides light beams 11 of a defined duration and defined direction for generating the traffic sign projection. The light beam L leaves the projection apparatus 30 through an optical device 39 which is used for beam focusing or correction.

In the exemplary embodiment shown, single-color circular images are projected onto the carriageway B or B′ with the traffic sign Z being projected in white for an asphalt grey carriageway B or B′. As a result of the projection from projection units 30 arranged overhead, this traffic sign Z is also visible on a snow-covered carriageway B or B′. With a snow-white carriageway B or B′ the light beam L can be colored orange, by means of a color filter 33 arranged in the projection apparatus 30 for example, so that the traffic sign Z possesses a sufficient contrast to the snow covering. By controlling color filter 33 and redirection device 34 in a suitable manner, multicolor traffic signs Z can also be projected onto the carriageway B or B′. Corresponding projection patterns PZ are also able to be realized for text information and also for scrolling lights or texts.

In an embodiment not shown the light source 32 is embodied for emitting an invisible light beam L. In such cases the carriageway B or B′ has a coating which is able to be excited by the invisible light to emit visible light. In a similar way in which black light transforms wavelengths not visible to the eye into visible wavelengths, confusing or disruptive visible light beams from projection apparatus 30 can be avoided by road users by this method.

1.-10. (canceled)

11. A traffic device for displaying a traffic sign on a carriageway along which a vehicle is able to drive, comprising:
a projection apparatus generates an optical projection of the traffic sign onto the carriageway,
wherein the projection apparatus is arranged by the side of the carriageway such that the projected traffic sign is perceivable by a driver of the vehicle.

12. The traffic device as claimed in 11, wherein the projection apparatus includes:
a light source that emits a light beam, and
a redirection device that influences a beam direction of the emitted light beam.

13. The traffic device as claimed in 12, wherein the projection apparatus includes a control device that co-ordinates control of the light source and of the redirection device.

14. The traffic device as claimed in claim 13, wherein the control device includes:
a memory unit that stores a plurality of projection patterns assigned to projectable traffic signs, and
a processing unit that executes a projection pattern.

15. The traffic device as claimed in 12, wherein the projection apparatus includes a control device that co-ordinates control of the light source or of the redirection device.

16. The traffic device as claimed in claim 15, wherein the control device includes:
a memory unit that stores a plurality of projection patterns assigned to projectable traffic signs, and
a processing unit that executes a projection pattern.

17. The traffic device as claimed in 12,
wherein the light source emits an invisible light beam, and
wherein the carriageway has a coating which when irradiated by the invisible light beam, is excited and emits visible light.

18. The traffic device as claimed in 11, wherein the projection apparatus project a multicolored traffic sign.

19. The traffic device as claimed in 11, wherein with the projection apparatus is arranged above the carriageway and essentially aligned perpendicular to the carriageway.

20. The traffic device as claimed in 11, wherein a plurality of projection apparatuses are distributively arranged and aligned such that each of the plurality of projection apparatuses projects the same traffic sign onto the same point of the carriageway from different directions.

21. The traffic device as claimed in 11, wherein the traffic sign is a static projection.

22. The traffic device as claimed in 21, wherein the static projection is of a prohibitive sign, a warning sign, danger sign, a traffic direction arrow, of a point or line-type carriageway marking or of an information text.

23. The traffic device as claimed in 11, wherein the traffic sign is a dynamic projection.

24. The traffic device as claimed in 11, wherein the dynamic projection is of a moving text.

25. The traffic device as claimed in 11, wherein the dynamic projection is of a moving light.
